(19) United States
(12) Patent Application Publication
(10) Pub. No.: US 2022/0351165 A1
(43) Pub. Date: Nov. 3, 2022

(54) Blockchain Fungible and Non-Fungible Tokenization of Physical Assets via Digital Twinning

(71) Applicant: VeriTX Corp., Buffalo, NY (US)

(72) Inventor: James Allen Regenor, East Aurora, NY (US)

(21) Appl. No.: 17/734,668

(22) Filed: May 2, 2022

Related U.S. Application Data
(63) Continuation-in-part of application No. 17/722,989, filed on Apr. 18, 2022.
(60) Provisional application No. 63/183,297, filed on May 3, 2021.
(60) Provisional application No. 63/182,424, filed on Apr. 30, 2021.
(60) Provisional application No. 63/185,599, filed on May 7, 2021.
(60) Provisional application No. 63/183,215, filed on May 3, 2021.
(60) Provisional application No. 63/183,235, filed on May 3, 2021.
(60) Provisional application No. 63/182,444, filed on Apr. 30, 2021.
(60) Provisional application No. 63/183,251, filed on May 3, 2021.
(60) Provisional application No. 63/183,272, filed on May 3, 2021.
(60) Provisional application No. 63/183,328, filed on May 3, 2021.
(60) Provisional application No. 63/183,663, filed on May 4, 2021.
(60) Provisional application No. 63/183,666, filed on May 4, 2021.

(51) Int. Cl. G06Q 20/12; G06F 21/10; G06Q 50/06

(52) U.S. Cl. CPC G06Q 20/1235; G06F 21/10; G06Q 50/06; G06Q 2220/165

(57) ABSTRACT

Provided is a system and method for creating, maintaining and tracking a cryptographic digital asset tied to physical asset, including creating a digital asset file representative of a respective physical asset; initializing a digital asset generator to create a blockchain-enabled NFT having a unique digital asset ID code; linking the unique digital asset ID code with a unique user ID code which is associated with the first party; creating a first transaction block in a distributed blockchain ledger to record possession with the first party; receiving an asset transfer request to transfer the digital asset and physical asset to a second party; verifying a second unique user ID code; linking the cryptographic digital asset with the second unique user ID code; and creating a second transaction block in the distributed blockchain ledger for recordation of the transfer of possession from the first party to the second party.

### CROSS REFERENCE TO RELATED APPLICATIONS

The present application is a continuation-in-part of U.S. patent application Ser. No. 17/722,989, filed on Apr. 18, 2022; and further claims the benefit of U.S. Provisional Patent No. 63/183,297, filed on May 3, 2021; U.S. Provisional Patent No. 63/182,424, filed on Apr. 30, 2021; U.S. Provisional Patent No. 63/185,599, filed on May 7, 2021; U.S. Provisional Patent No. 63/183,215, filed on May 3, 2021; U.S. Provisional Patent No. 63/183,235, filed on May 3, 2021; U.S. Provisional Patent No. 63/182,444, filed on Apr. 30, 2021; U.S. Provisional Patent No. 63/183,251, filed on May 3, 2021; U.S. Provisional Patent No. 63/183,272, filed on May 3, 2021; U.S. Provisional Patent No. 63/183,328, filed on May 3, 2021; U.S. Provisional Patent No. 63/183,663, filed on May 4, 2021; and U.S. Provisional Patent No. 63/183,666, filed on May 4, 2021, each of which is hereby incorporated by reference in its entirety.

### TECHNICAL FIELD

The present application relates generally to a computerized system and method for creating, distributing and/or monitoring cryptographically secured digital assets. Additionally, aspects of the application relate to decentralized computing systems and blockchain control logic.

### BACKGROUND

The need to provide data provenance via identification, tracking and maintaining equipment and materials vital to national security has only increased as global tensions continue to mount. Non-limiting examples of such equipment and materials include commercial and military aircraft parts and assemblies, nuclear materials and components, as well as the parts and supplies needed to maintain such equipment and materials. Decentralized systems using blockchain technology provide for the secure, verifiable and immutable asset management needed to ensure data integrity.

### SUMMARY

Blockchain technology may assist monetization of assets through digital twinning whereby a physical asset is reproduced as a digital copy and tokenized. The tokenized digital asset may provide a digital record the execution flow and provided verifiable identity within the blockchain provenance and execution record of the blockchain transactions. Additionally, the production output of select assets may also be tokenized in non-fungible tokens. These non-fungible tokens can then be bought and sold on a tokenized commodities exchange leveraging smart contracts for remuneration and transaction expediency.

Briefly described, one aspect of the present invention provides for a method for creating, maintaining, and tracking a cryptographic digital asset tied to physical asset. The method comprises creating, via a first computing node within a distributed computing network, a digital asset file representative of a respective physical asset in possession of a first party; initializing a digital asset generator to create a blockchain-enabled non-fungible token (NFT) of the digital asset file, wherein the NFT is assigned a unique digital asset identification (ID) code; linking the unique digital asset ID code with a unique user ID code, wherein the unique user ID code is associated with the first party; creating a first transaction block including the unique digital asset code and the unique user ID code, via the first computing node in a distributed blockchain ledger, to record possession of the cryptographic digital asset and the respective physical asset with the first party; receiving an asset transfer request to transfer the cryptographic digital asset and respective physical asset to a second party; verifying a second unique user ID code which is associated with the second party; linking the cryptographic digital asset with the second unique user ID code; and creating a second transaction block including the unique digital asset ID code and the second unique user ID code in the distributed blockchain ledger for recordation of the transfer of possession of the cryptographic digital asset and the respective physical asset from the first party to the second party.

A further aspect of the present invention provides for a decentralized computing system for creating, maintaining, and tracking a cryptographic digital asset tied to physical asset. The decentralized computing system comprises a cryptographic digital asset marketplace configured to store a plurality of digital assets and a plurality of unique digital asset identification (ID) codes; and a first computing node operatively connected to the cryptographic digital asset marketplace. The first computing node is programmed to: create a digital asset file representative of a respective physical asset in possession of a first party; initialize a digital asset generator to create a blockchain-enabled non-fungible token (NFT) of the digital asset file, wherein the NFT is assigned a respective unique digital asset ID code; link the respective unique digital asset ID code with a unique user ID code, wherein the unique user ID code is associated with the first party; create a first transaction block including the respective unique digital asset ID code and the unique user ID code, via the first computing node in a distributed blockchain ledger, to record possession of the cryptographic digital asset and the respective physical asset with the first party; receive an asset transfer request to transfer the cryptographic digital asset and respective physical asset to a second party; verify a second unique user ID code which is associated with the second party; link the cryptographic digital asset with the second unique user ID code; and create a second transaction block including the respective unique digital asset ID code and the second unique user ID code in the distributed blockchain ledger for recordation of the transfer of possession of the cryptographic digital asset and the respective physical asset from the first party to the second party.

In another aspect of the present invention, an exemplary embodiment may be directed toward systems and methods to leverage blockchain Non-Fungible Tokens (NFTs) to create a decentralized verifiable custody chain for aircraft tooling-equipment and other tools-equipment consigned or assigned to a tool/equipment locker for sign out and sign in accountability. An embodiment of the invention may allow for the tool/equipment provenance from initial sign-out to use to sign-in via a blockchain-enabled NFT. Blockchain smart contracts may be employed to define the terms and conditions of tool and equipment usage and for remuneration of fees to the part assigned or consigner per the tool locker contracts.

Additionally, the solution may leverage Verifiable Self Sovereign Identification (VSSI) and a key pair to secure to locker transactions for sign-out, use and sign-in. Whereas, users may be assigned a VSSI and the NFTs may record the transactions via VSSI and key pairing between the consigner and user in the tool locker. The NFT will provide a digital record of the sign-out, use, and sign-in of the tool or equipment flow and provide verifiable identity within the provenance and execution record of the transactions.

In a further aspect of the present invention, an exemplary embodiment may be directed toward providing systems and methods to leverage blockchain Non-Fungible Tokens (NFTs) to create a decentralized verifiable custody chain for aircraft and other complex machinery parts consigned to a rotable pool. An exemplary embodiment of the invention allows for part provenance from initial requirements to full part lifecycle management via a blockchain enabled digital twin. This allows for the strict control procedures and processes needed to manage rotable pools between the vendors who consign their parts and the members/consumers of the rotables. Additionally, blockchain smart contracts may be employed to define the terms and conditions of the pool participation and for remuneration of fees to the part consigner per the rotable contracts.

Additionally, an aspect of the invention may leverage VSSI and a key pair to secure the rotable pool. That is, users may be assigned a VSSI and the NFTs may record the transactions via VSSI and key pairing between the consigner and consumer. The NFT may provide a digital record the execution flow and provided verifiable identity within the provenance and execution record of transactions.

In still another aspect of the present invention, an exemplary embodiment may be directed toward systems and methods to leverage blockchain Non-Fungible Tokens (NFTs) to create a decentralized verifiable custody chain for Nuclear Warheads, Critical Nuclear Components, and Nuclear Fissible Materials. The invention may include an embodiment which allows for the creation and assembly of nuclear warheads and devices so that all the material, sub-component, and component parts' provenance will be embedded in a NFT construct. This may allow for the strict command and control procedures currently in place with the Department of Defense, Department of Energy and the National Nuclear Security Administration. The NFTs may create a vehicle to monitor regulatory compliance in an immutable manner while further enhancing security of the world's nuclear stockpiles. Additionally, this embodiment may provide the needed reporting procedures and transparency as defined in treaty provisions.

Each (nuclear) NFT may have blockchain transaction provenance traceable to individuals, organizations and assigned treaty provisions. This information may support Defense Threat Reduction Agency, Nuclear Regulatory, Air Force Safety Center, Department of Energy and NNSA Audit and Inspection requirements.

Additionally, the fail-safe lock of the nuclear devices may be paired with Verifiable Self Sovereign Identification (VSSI) credentials to enhance nuclear security. Additionally, the solution may leverage VSSI and a key pair to secure the execution flow and provided verifiable identity within the provenance and execution record of transactions.

In still another aspect of the present invention, an exemplary system and method may create a decentralized verifiable custody chain for leases and lease records of high value machinery, planes, aircraft engines, yachts, and exotic automobiles. Trusted provenance of leases is foundational to maintaining the value of the asset through the lease term and beyond. By using NFTs and verifiable identity credentials, lease and lease records, terms and conditions and agreed to modifications may be established and maintained. Additionally, any penalties or damages can be recorded and remunerated against via a blockchain smart contract. A record of all the “touches” of that lease and leased asset can be maintained as the provenance of that item. Additionally, blockchain smart contracts can be used to delegate access to the lease and leased object and used to define terms and conditions of use for each assignee.

In still another aspect of the present invention, an exemplary system and method may create a decentralized verifiable custody chain for digital and physical evidence collected by law enforcement, medical examiners and forensic specialists for prosecution in criminal cases and litigation in civil cases. By using NFTs and verifiable identity credentials, control of evidence can be established and maintained. A record of all the “touches” of that evidence can be maintained as the provenance of that item. Additionally, blockchain smart contracts can be used to delegate access to the evidence and define terms and conditions of use for each assignee. This solution will enable secure physical and digital evidence lockers/vaults. The NFT will provide a digital record of the sign-out, use, and sign-in of the evidence and provide verifiable identity within the provenance and execution record of transactions.

In still another aspect of the present invention, an exemplary system and method may create a decentralized verifiable custody chain for feature film and documentary production and distribution. By using NFTs and verifiable identity credentials, one can establish and maintain control of the ownership, credits and distribution rights of the film. Parties associated with the film's development from initial idea through production can participate in ownership and be remunerated based on their investment or contract. Outside investors can acquire fractional ownership of the film. An NFT exchange may facilitate the buying, selling and transfer of the NFT and fractionals. Additionally, blockchain smart contracts may be employed to define the terms and conditions of the project to the individual participants. The NFT can also combat counterfeit movies using blockchain and smart contracts as an attestation to authenticity.

In still another aspect of the present invention, an exemplary system and method may create a decentralized verifiable custody chain for human donor, lab grown or 3D Printed organs and body parts and pieces for transplant into humans. By using NFTs and verifiable identity credentials, one can establish and maintain control of the organ, part or piece provenance from initial requirements through full life cycle. A record of all the “touches” of that data can be maintained as the provenance of that information. Additionally, any modifications or changes to the organs, parts or pieces may be tracked. Additionally, blockchain smart contracts may be employed to define the terms and conditions of the acceptance of the transplanted organ, part or piece. This solution enables secure IP libraries of organ and patient data.

In still another aspect of the present invention, an exemplary system and method may create a decentralized verifiable custody chain for intellectual property (IP) and trade secret information for companies in the industrial, medical and consumer market verticals. Theft of IP and trade secret information has long been a problem and security of that information has been a challenge. By using NFTs and verifiable identity credentials, control of the IP and trade secret data may be established and maintained. A record of all the “touches” of that data can be maintained as the provenance of that information. Additionally, any modifications, changes and/or upgrades of the underlying parts, devices and/or components may be tracked and revise control for the underlying parts, components and device can all be maintained. Additionally, blockchain smart contracts will be employed to define the terms and conditions of the IP and trade secret information within the value chain both up and down stream. The NFT also provides a digital record of the sign-out, use, and sign-in of the IP or trade secrets and provides verifiable identity within the provenance and execution record of transactions.

In still another aspect of the present invention, an exemplary system and method may create a decentralized Contingency Plans (CONPLAN); Operations Plans (OPLAN) and Time Phased Force Deployment Data (TPFDD). Each of these NFTs represents a defined unit capability to be executed within the specific plans via Joint Operation Planning and Execution System (JOPES) and this system is part of the Global Command and Control System (GCCS). The present invention leverages blockchain smart contracts and verifiable credentials to delegate roles, permissions and authorities as assigned in the specific plan for deployment, employment, execution and reconstitution for the forces and capabilities represented by the NFTs. The present invention will allow for the creation of unit capabilities based NFTs congruent with the strategy. Those tokens will be utilized and prioritized by JOPES planners with the development of the strategy. That unit capabilities list will be maintained by the service planners and attached via smart contract to the POM (Program Objective Memorandum) for funding. This solution allows for compression of the planning, deployment, employment, and execution cycle times. Each NFT (unit capability) has blockchain provenance traceable back to the strategy and POM with all the associated raw data, assessments, prioritizations, TPFDD sequences and priorities. Execution of the plan is via a blockchain based smart contract enabling command and control from the National Command Authorities through the appropriate operational and tactical commanders. Additionally, the solution leverages Self Sovereign Identification (SSI) to secure the execution flow and provides verifiable identity within the provenance and execution record of transactions. The solution also uses NFTs and verifiable identity to delegate roles and authorities for NFT, plan branches and sequels and execution.

In still another aspect of the present invention, an exemplary system and method may create a decentralized verifiable authenticity of high value livestock and animal provenance and bloodline authenticity. By using NFTs and verifiable identity credentials, control of the high value livestock or animal provenance may be established and maintained from birth through life. The animal's history can be recorded, as well as any other significant event. The animal's genetics and medical history can also be recorded in the NFT as an attestation of the value of the animal. A record of all the “touches” of that data can be maintained as the provenance of that information. Additionally, blockchain smart contracts may be employed to define the terms and conditions of insemination of the animal or use of the animal's semen for insemination. This enables secure libraries of transactions and bloodlines. The NFT structure of the animal's provenance also facilitates valuation used in a buy/sell exchange or the buying and selling of animal semen for reproduction and bloodline extension. Additionally, NFTs will provide an expeditious form of remuneration and settlement.

In still another aspect of the present invention, an exemplary system and method may create a decentralized verifiable custody and provenance of mineral and water rights, including provenance (ownership), liens and encumbrances, regulatory compliance, and legal requirements. This allows for the strict control, compliance, and transfer procedures and processes needed to manage mineral/water rights between the owners who sell, lease, or consign their mineral rights and the parties that extract the materials from the earth and sell them. Additionally, blockchain smart contracts may be employed to define the terms and conditions of the extraction of the minerals and/or water. Blockchain smart contracts may be employed for remuneration of fees to the rights owners and to define the terms and conditions to lessee, consigner, or owner per the mineral/water rights contract. Additionally, the solution leverages Verifiable Self Sovereign Identification (VSSI) and a key pair to secure to the rights and provenance. Members are assigned a VSSI and the NFTs record the transactions via VSSI and key paring between the lessee, consigner and owner. The NFT will provide a digital record of the execution flow and provides verifiable identity within the provenance and execution record of transactions. Additionally, NFTs will allow for the quick sale, transfer or auction of the mineral/water rights.

In still another aspect of the present invention, an exemplary system and method may create a decentralized verifiable custody and provenance of electricity producing wind turbines/windmills. In an embodiment, the invention allows for the wind turbine/windmill provenance and performance from initial requirements to full well lifecycle management via a blockchain enabled digital twin. This allows for the strict control procedures and processes needed to manage wind turbines/windmills between the vendors who sell, lease, or consign their wind turbines/windmills and the field or landowners. Additionally, blockchain smart contracts may be employed to define the terms and conditions of the wind turbine/windmill participation and for remuneration of fees to the wind turbine/windmill lessee, consigner, or owner per the well contracts. Additionally, the production output of the wells may be tokenized in fungible or non-fungible tokens based on production units, such as kilowatts per hour. These fungible or non-fungible tokens may be bought and sold on a tokenized commodities exchange leveraging smart contracts for remuneration and transaction expediency.

In still another aspect of the present invention, exemplary system and method may create a decentralized verifiable custody and provenance oil, gas and water wells from initial requirements to full well lifecycle management via a blockchain enabled digital twin. Additionally, blockchain smart contracts may be employed to define the terms and conditions of the well participation and for remuneration of fees to the well lessee, consigner, or owner per the well contracts. Additionally, the solution would leverage Verifiable Self Sovereign Identification (VSSI) and a key pair to secure to the well and provenance. Members are assigned a VSSI and the NFTs record the transactions via VSSI and key paring between the lessee, consigner and owner. The NFT thus provides a digital record the execution flow and provided verifiable identity within the provenance and execution record of transactions. Additionally, the production output of the wells may be tokenized, with those tokens then being bought and sold on a tokenized commodities exchange leveraging smart contracts for remuneration and transaction expediency. Additionally, the NFTs allow for the quick sale, transfer or auction of the well and/or its contents.

In still another aspect of the present invention, an exemplary system and method may create a decentralized verifiable custody chain for oil and gas rigs from initial requirements to full rig lifecycle management via a blockchain enabled digital twin. Additionally, blockchain smart contracts may be employed to define the terms and conditions of the rig participation and for remuneration of fees to the rig lessee, consigner, or owner per the rig contracts. Verifiable Self Sovereign Identification (VSSI) and a key pair may be used to secure the rig and provenance where members are assigned a VSSI and the NFTs record the transactions via VSSI and key paring between the lessee, consigner and owner. The NFT can then provide a digital record the execution flow and provided verifiable identity within the provenance and execution record of transactions. Additionally, the NFTs may also allow for the quick sale, transfer or auction of the rig.

### BRIEF DESCRIPTION OF THE DRAWINGS

FIG. 1 is a diagram of an exemplary decentralized computing system for creating, distributing and/or monitoring cryptographically secured digital assets in accordance with an aspect of the present invention;

FIG. 2 is a flowchart showing an exemplary workflow algorithm for creating, distributing and/or monitoring cryptographically secured digital assets protected by cryptographic tokens on a blockchain ledger, which may correspond to memory-stored instructions executed by control-logic circuitry, programmable electronic control unit, or other computer-based device or network of devices in accordance with an aspect of the present invention;

FIG. 3 is an illustration of an exemplary workflow for managing tools and/or equipment through tokenization of cryptographic digital assets in accordance with an aspect of the present invention;

FIG. 4 is an illustration of an exemplary workflow for managing rotable part pools using tokenization of cryptographic digital assets in accordance with an aspect of the present invention;

FIG. 5 is an illustration of an exemplary tokenization of nuclear materials for custody verification and tracking in accordance with an aspect of the present invention;

FIG. 6 is an illustration of an exemplary workflow for managing leases and lease records in accordance with an aspect of the present invention;

FIG. 7 is an illustration of an exemplary workflow for managing physical and digital investigative evidence for criminal investigations and prosecution and civil litigation in accordance with an aspects of the present invention;

FIG. 8 is an illustration of an exemplary tokenization of feature film and documentary production and distribution in accordance with an aspects of the present invention;

FIG. 9 is an illustration of an exemplary workflow for managing human donor, lab grown or 3D printed organs, body parts and pieces for transplant in accordance with an aspects of the present invention;

FIG. 10 is an illustration of an exemplary workflow for managing intellectual property and trade secret information in accordance with an aspects of the present invention;

FIG. 11 is an illustration of an exemplary tokenization for CONPLAN, OPLANS or TPFDD execution in accordance with an aspects of the present invention;

FIG. 12 is an illustration of an exemplary workflow for managing high value livestock and show or racing animals and their bloodlines in accordance with an aspects of the present invention;

FIG. 13 is an illustration of an exemplary tokenization of mineral and water rights verification and track/trace of rights, ownership and delegation in accordance with an aspects of the present invention;

FIG. 14 is an illustration of an exemplary workflow for management of windmills and commodities exchange of electric output in accordance with an aspects of the present invention;

FIG. 15 is an illustration of an exemplary workflow for tokenization of oil, gas and water well management and commodities exchange in accordance with an aspects of the present invention; and

FIG. 16 is an illustration of an exemplary workflow for management of oil and gas rigs via digital twinning in accordance with an aspects of the present invention.

### DETAILED DESCRIPTION

As used herein, the terms “cryptographic digital assets,” and/or “digital assets” may refer to any computer-generated virtual object that has a unique, non-fungible tokenized code (“token”) registered on and validated by a blockchain platform or otherwise registered in an immutable database.

As described in greater detail below, each unique token (NFT) may be directly linked to a single physical object or asset, which may be reproduced as a virtual reproduction or digital version. In one embodiment, the token may include a 64-bit alphanumeric code that is sectioned into individual code segments where one or more or all of the code segments of the alphanumeric code may express data indicative of attributes of the physical asset or asset location or ownership. During the creation of each token, a smart contract may be generated to authenticate ownership and to track future transactions of the token on a blockchain-based distributed computing platform.

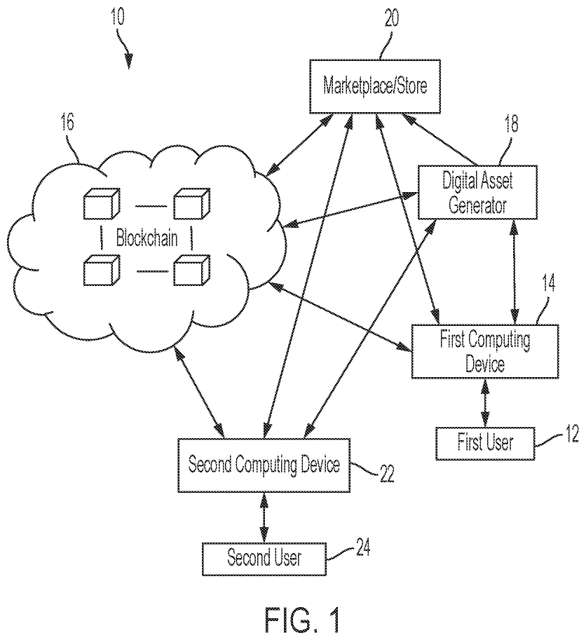

Referring now to the drawings, FIG. 1 shows an exemplary decentralized computing system 10 in accordance with the present invention. Decentralized computing system 10 includes blockchain control logic for mining, intermingling, and exchanging blockchain-enabled digital assets. As shown in FIG. 1, a first user 12 may operatively interface with a first computing device 14, such as but not limited to one or more of a smart phone, smart watch, a tablet, laptop or desktop computer, or other similar devices. First computing device 14 may be operatively configured to communicate with blockchain network 16. Blockchain network 16 is an immutable public database. First computing device may further operatively communicate with digital asset generator 18 and digital marketplace/store 20.

In one aspect of the invention, blockchain network 16 may include at least one non-fungible token (NFT) registered thereon which represents a tangible physical asset. The NFT may be generated via digital asset generator 18 and may include genomic information regarding the physical asset, such as but not limited to the location and owner of the physical asset, the part or serial number of the physical asset, the condition of the physical asset, and the like. First user 12 also possesses a digital wallet or locker that includes a private cryptographic key associated solely with first user 12. This unique key (user ID) allows first user 12, through first computing device 14, to read encrypted data associated with a linked token as well as enable transfer of ownership of the NFT. It should be noted that a cryptocurrency wallet/locker is used to store public and private key pairs but does not store the cryptocurrency itself. Instead, the cryptocurrency is decentralized and maintained in a publicly available blockchain ledger. With the stored keys, first user 12 may digitally sign a transaction and write it to the blockchain ledger. In one aspect of the present invention a smart contract associated with the wallet/locker may be used to automatically transfer assets and create a verifiable audit trail of every transfer.

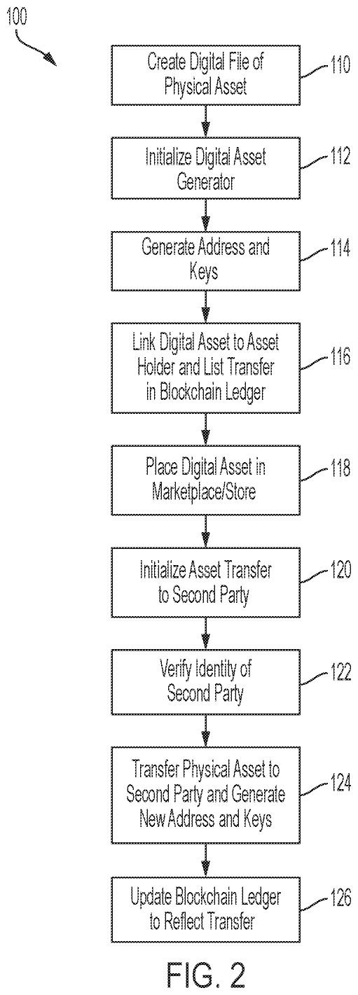

Turning now to FIG. 2, a method 100 for creating, maintaining and tracking a cryptographic digital asset tied to physical asset in accordance with an aspect of the present invention is shown. Some or all of the operations of the algorithm constituting method 100 may be processor-executable instructions stored in a memory and executable via a central processing unit (CPU), control logic circuit, or other module or device or network of devices. Unless expressly stated otherwise or required by logic, it should be understood by those skilled in the art that the order of execution of the steps of method 100 may be changed and that steps may be added, modified, combined, or deleted so long as the resultant method performs as intended herein.

As shown in FIG. 2, method 100 begins at step 110 with the creation of a digital file of the physical asset, such as but not limited to, a digital photograph which may then be stored in the memory of first computing device 14. First computing device 14 may then be used by first user 12 at step 112 to issue processor-executable instructions to initialize digital asset generator 18 to generate a cryptographic digital asset. The digital asset is generated as an NFT as described above and includes a unique digital asset ID code and any genomic information entered by first user 12 at step 114. At step 116, the unique digital asset ID code is linked with the unique user ID code of first user 12 and a first transaction block is created in a distributed blockchain ledger in blockchain network 16. The blockchain ledger thereby records possession of the cryptographic digital asset and the respective physical asset with first user 12. The digital asset may then be placed within a digital marketplace or store at step 118 whereby possession and/or ownership of the digital asset and physical asset may be freely transferred to a second party.

As shown at step 120, a second user 22 using a second computing device 24, such as smartphone or smartwatch (see FIG. 1) may access the digital marketplace 20 to initiate transfer of the digital asset and its associated physical asset. Second user 22 enters personal information (i.e., a user ID and associated blockchain locker/wallet) which is then verified and validated (step 122). Upon validation, the digital (and physical) asset is transferred from first user 12 to second user 24 whereby the digital asset receives a unique, encrypted asset code with an address, a token, and a public and private key pair (step 124) which is the added to the blockchain ledger at step 126.

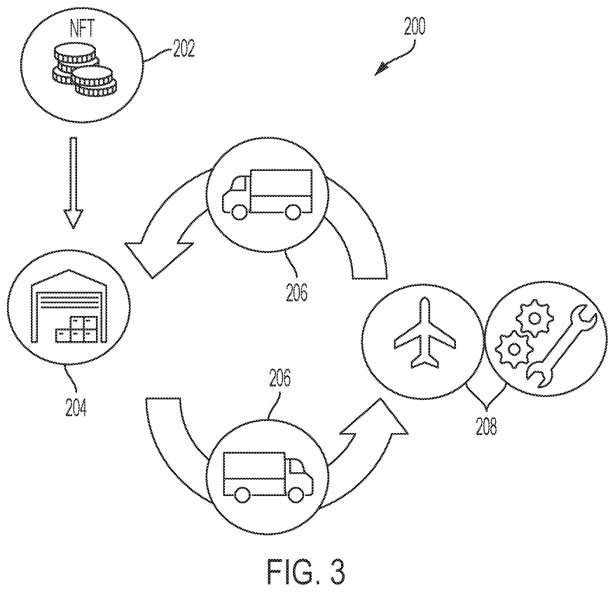

Turning now to FIG. 3, a first embodiment of an exemplary system configured to use system 10 and method 100 is generally references as system 200. System 200 uses tokenized tools and equipment 202 consigned or assigned to a common location or locker 204 for sign-out and sign-in accountability. System 200 allows for the tool and equipment provenance from initial sign-out to use to sign-in via blockchain enabled NFTs 202. The physical tools and equipment are digitally twinned to create digital asset files to enable monitoring of the cycles and use of the tools and equipment. Tokenization of the physical items allows for the implementation of strict control procedures and processes needed to manage the tools and equipment between vendors 206 who assign or consign their tools and equipment to locker 204 for use in maintenance and repairs of aircraft 208.

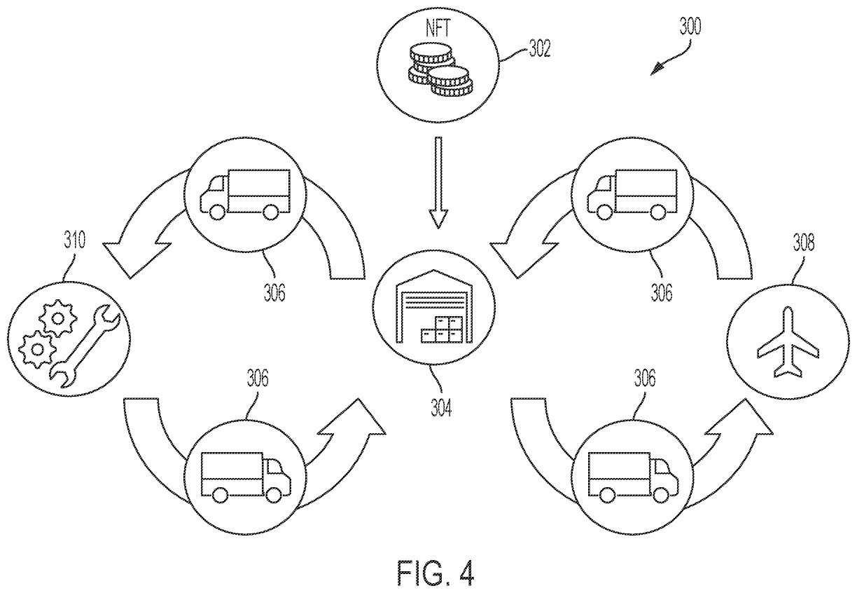

With reference to FIG. 4, an alternative system 300 configured to use system 10 and method 100 is shown. System 300 is directed to a decentralized verifiable custody chain for aircraft and other complex machinery parts 302 consigned to a rotable pool 304. Similar to system 200 described above, system 300 allows for the implementation of strict control procedures and processes needed to manage the rotable parts between vendors 306 who assign or consign their parts to pool 304 for use in maintenance and repairs of aircraft 308, as well as to monitor and manage repairs to such rotable parts by third party repair technicians 310.

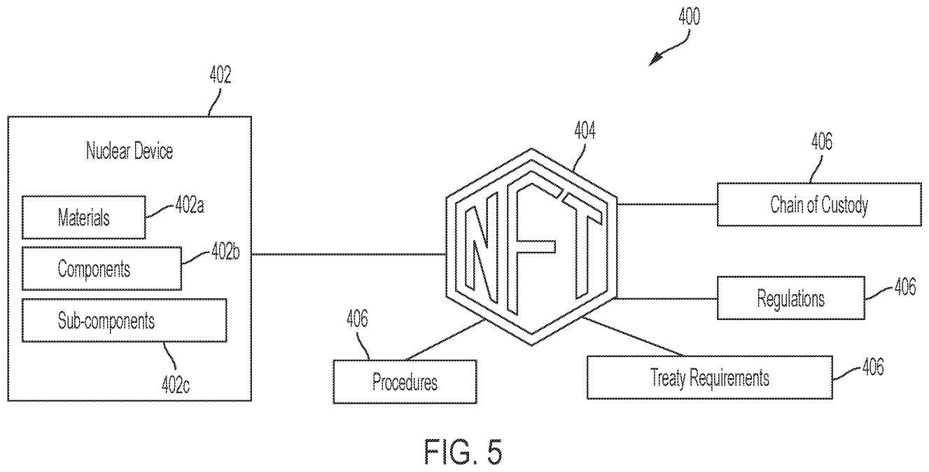

As shown in FIG. 5, exemplary system 400 is configured to use system 10 and method 100 to create a decentralized verifiable custody chain for nuclear devices 402 including warheads, critical nuclear components, and nuclear fissile materials through creation of unique NFTs 404. In one aspect of the invention, an exemplary embodiment of system 400 allows for the creation and assembly of nuclear warheads and devices 402 so that all the material 402a, sub-component 402b, and component 402c parts' provenance will be embedded in a non-Fungible Token (NFT) construct 404. NFTs 404 allow for the strict command and control procedures 406 currently in place with the Department of Defense, Department of Energy and the National Nuclear Security Administration, as well as create a vehicle to monitor regulatory compliance in an immutable manner while further enhancing security of the world's nuclear stockpiles. Additionally, system 400 may provide the needed reporting procedures and transparency as defined in treaty provisions. Additionally, the fail-safe lock of the devices 402 can be paired with verifiable self-sovereign identification (VSSI) credentials to enhance nuclear security.

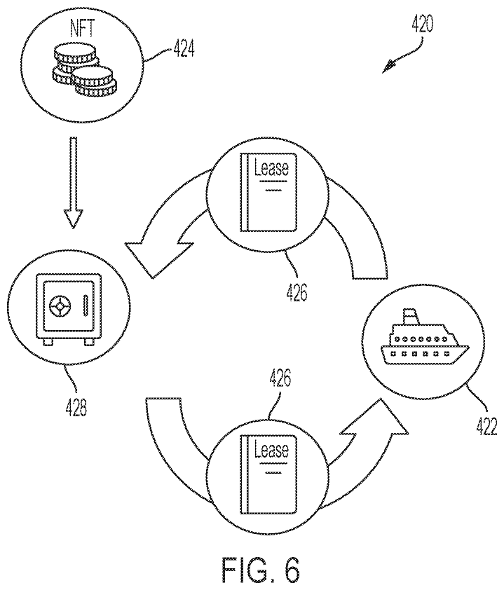

Turning now to FIG. 6, exemplary system 420 is configured to use system 10 and method 100 to create a decentralized verifiable custody chain for leases and lease records of high value machinery, planes, aircraft engines, yachts, and exotic automobiles 422. Trusted provenance of leases is foundational to maintaining the value of the asset through the lease term and beyond. By using NFTs and verifiable identity credentials 424, lease and lease records 426, and the terms conditions and agreed to modifications control can be established and maintained. Additionally, any penalties or damages can be recorded and remunerated against via blockchain smart contract. A record of all the “touches” of that lease and leased asset may be maintained as the provenance of that item. Additionally, blockchain smart contracts may be used to delegate access to the lease and leased object and used to define terms and conditions of use for each assignee. As a result immutable transparent truth is created and maintained within the lease transaction. The NFT provides a digital record 428 of the leased asset for the term of the lease and provide verifiable identity within the provenance and execution record of transactions.

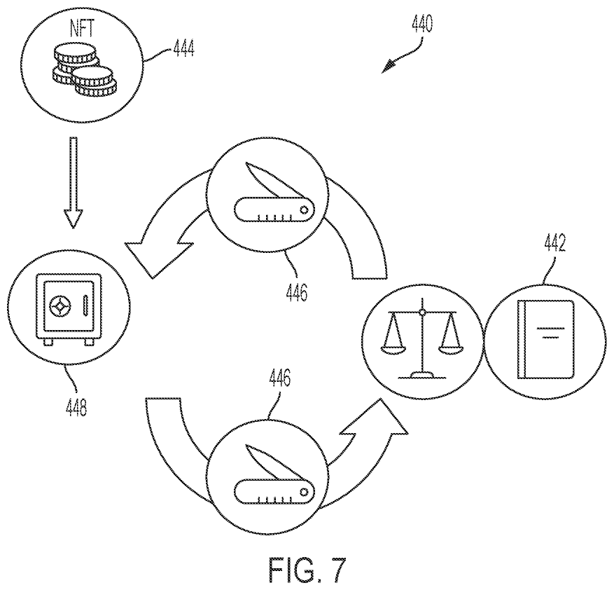

Turning now to FIG. 7, exemplary system 440 is configured to use system 10 and method 100 to create a decentralized verifiable custody chain for digital and physical evidence 442 collected by law enforcement, medical examiners and forensic specialists for prosecution in criminal cases and litigation in civil cases. Trusted provenance of evidence is foundational to a fair judicial system. Trust consensus may be ensured by using NFTs and verifiable identity credentials 444. A record of all the “touches” 446 of that evidence may be maintained as the provenance of that item. Additionally, blockchain smart contracts can be used to delegate access to the evidence and define terms and conditions of use for each assignee. As a result, secure physical and digital evidence lockers/vaults 448 may be enabled whereby NFT 444 provides a digital record of the sign-out, use, and sign-in of the evidence and provide verifiable identity within the provenance and execution record of transactions.

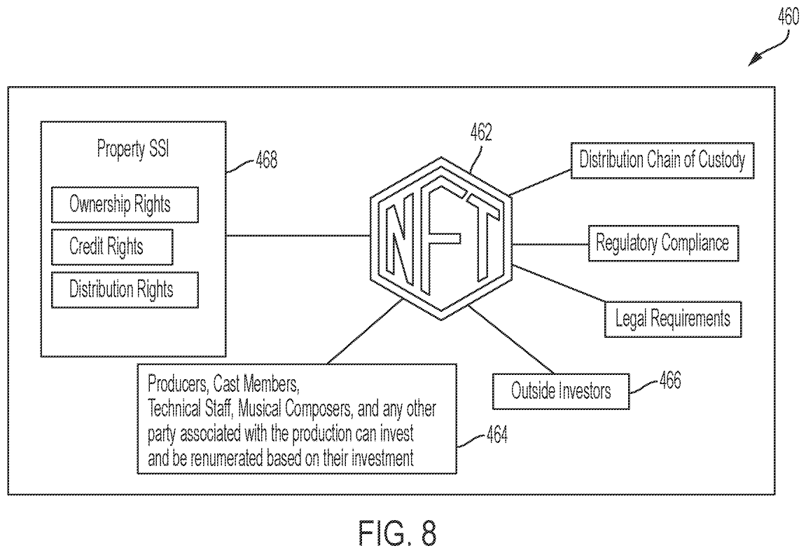

Turning now to FIG. 8, exemplary system 460 is configured to use system 10 and method 100 to create a decentralized verifiable custody chain for feature film and documentary production and distribution. NFTs and verifiable identity credentials 462 establish and maintain control of the ownership, credits and distribution rights of the film. Parties 464 associated with the film development from initial idea through production can participate in ownership and be remunerated based on their investment or contract. Outside investors 466 can acquire fractional ownership of the film. The value of NFT 462 may change depending on various factors, such as the identity of the actors signed onto the project and the distribution contracts. As a result, the value of the film can change from project initiation to conclusion. Additionally, the value could change following release, such as upon receiving one or more film or acting awards.

In one aspect of the present invention, an NFT exchange may facilitate the buying, selling and transfer of the NFT/fractionals 462. Using blockchain smart contracts, investors, contributors, and distributors can be remunerated. Additionally, blockchain smart contracts may be employed to define the terms and conditions of the project to the individual participants. A secure film library may also be created through NFTs 462 that covers the entire film or individual clips within the film for use in secondary markets and will provide an expeditious form of remuneration and settlement. NFTs 462 may also combat counterfeit movies using blockchain and smart contracts as an attestation to authenticity and may also provide a functional vehicle for exchange transactions between buyers and sellers.

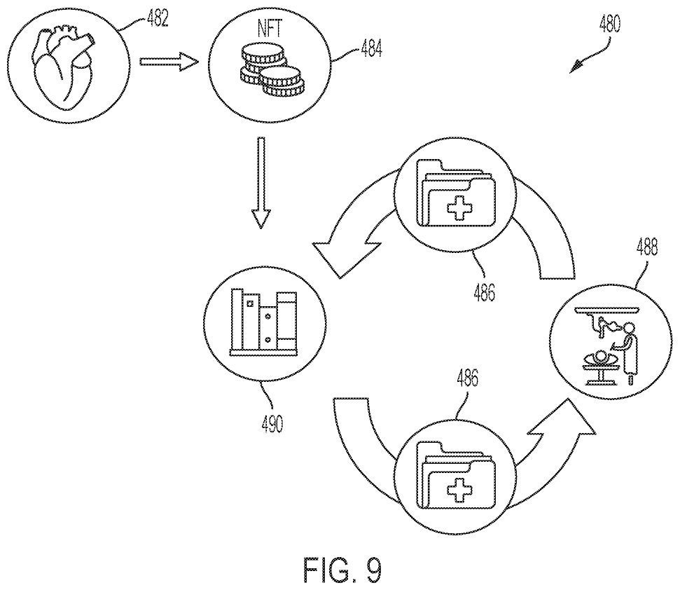

Turning now to FIG. 9, exemplary system 480 is configured to use system 10 and method 100 to create a decentralized verifiable custody chain for human donor, lab grown or 3D Printed organs and body parts and pieces 482 for transplant into humans. NFTs and verifiable identity credentials 484 may establish and maintain control of the organ, part or piece provenance from initial requirements through full life cycle. A record of all the “touches” 486 of that data can be maintained as the provenance of that information. Any modifications or changes made to the organs, parts or pieces 482 may be tracked via the respective NFT. Revision control for the underlying processes, procedures, and sequences can also be maintained. Using a blockchain smart contract inventors, contributors and donors 488 of the organ, part or piece 482 can be remunerated with its use. Additionally, blockchain smart contracts may be employed to define the terms and conditions of the acceptance of the transplanted organ, part or piece. Thus, in accordance with an aspect of the invention a secure IP library 490 of organ and patient data may be created that can generate a functional marketplace vehicle for exchange transactions between buyers and sellers. Additionally, NFTs 482 may provide an expeditious form of remuneration and settlement.

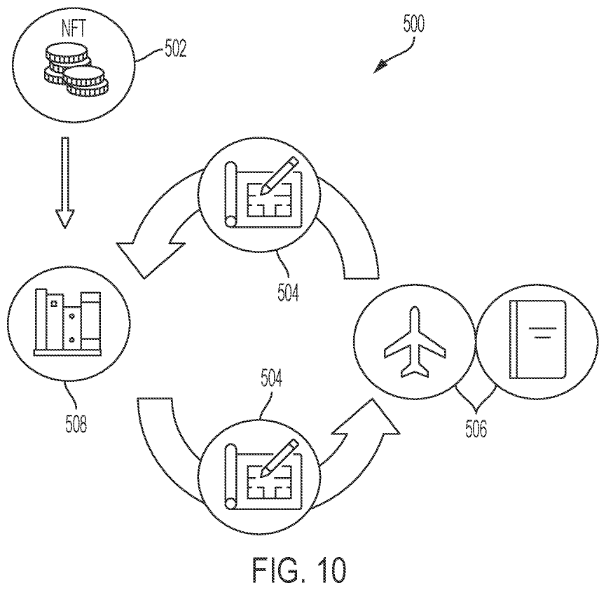

Turning now to FIG. 10, exemplary system 500 is configured to use system 10 and method 100 to create a decentralized verifiable custody chain for intellectual property (IP) and trade secret information for companies, such as in the industrial, medical and consumer market verticals. Theft of IP and trade secret information has long been a problem and security of that information has been a challenge. By using NFTs and verifiable identity credentials 502, control of the IP and trade secret data can be established and maintained. A record of all the “touches” 504 of that data are maintained as the provenance of that information. Any modifications, changes or upgrades of the underlying parts, devices or components can also be tracked while revision control for the underlying parts, components and device can also be maintained. Using blockchain smart contracts, inventors and contributors 506 to the IP or trade secret information can be remunerated, such as through invention royalties in accordance with the terms of the smart contract. Additionally, blockchain smart contracts may be employed to define the terms and conditions of the IP and trade secret information within the value chain, both up and down stream. Secure IP and trade secrets libraries 508 may also be created whereby the NFTs 502 provide a digital record of the sign-out, use, and sign-in of the IP or trade secrets and provide verifiable identity within the provenance and execution record of transactions.

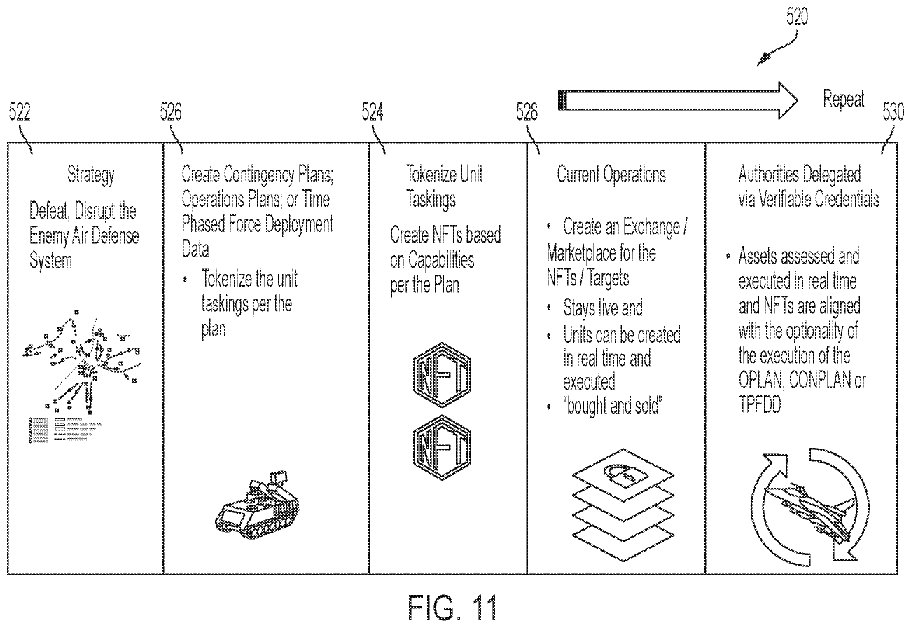

Turning now to FIG. 11, exemplary system 520 is configured to use system 10 and method 100 to create a decentralized Contingency Plan (CONPLAN); Operations Plan (OPLAN) and Time Phased Force Deployment Data (TPFDD) 522. Each of the NFTs 524 represents a defined unit capability 526 that may be executed within the specific plans via Joint Operation Planning and Execution System (JOPES) which is part of the Global Command and Control System (GCCS). Blockchain smart contracts and verifiable credentials may be leveraged to delegate roles, permissions and authorities as assigned in the specific plan for deployment, employment, execution and reconstitution for the forces and capabilities represented by the NFTs 524. NFTs 524 may then be utilized and prioritized by JOPES planners with the development of the strategy and the unit capabilities list will be maintained by the service planners and attached via smart contract to a POM (Program Objective Memorandum) for funding the plan for execution 528. This will allow for compression of the planning, deployment, employment, and execution cycle times. Each NFT (unit capability) has blockchain provenance traceable back to the strategy and POM with all the associated raw data, assessments, prioritizations, TPFDD sequences and priorities associated therewith. Execution of the plan 528 may be via a blockchain-based smart contract which enables command and control from the National Command Authorities through the appropriate operational and tactical commanders. Additionally, Self Sovereign Identification (SSI) may be leveraged to secure the execution flow and provide verifiable identity within the provenance and execution record of transactions. The NFTs and verifiable identity may also be used to delegate roles and authorities for NFT, plan branches and sequels and execution 530.

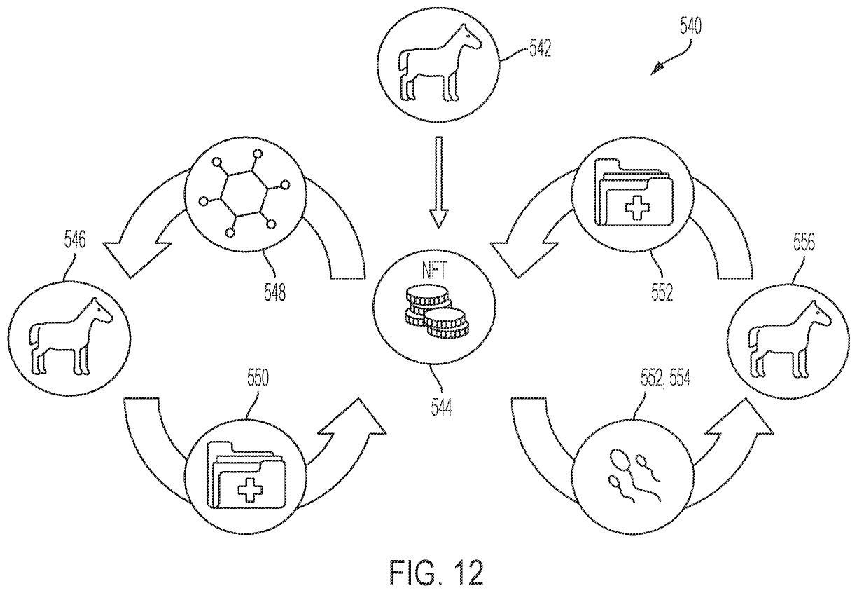

Turning now to FIG. 12, exemplary system 540 is configured to use system 10 and method 100 to create a decentralized verifiable authenticity of high value livestock and animal provenance and bloodline authenticity 542. NFTs and verifiable identity credentials 544 may be used to establish and maintain control of the high value livestock or animal or piece provenance from birth through its whole life. The animal's history in shows/races 546, as well as any significant event, may be recorded within the NFT blockchain. The animal's genetics 548 and medical history 550 can also be recorded in the NFT as an attestation of the value of the animal 542. A record of all the “touches” 552 of the blockchain data may be maintained as the provenance of that information. Additionally, blockchain smart contracts may be employed to define the terms and conditions of insemination of the animal 556 or use of the animal's semen 554 for insemination. Secure IP libraries of transactions and bloodlines can be created and maintained and the NFT structure of the animal's provenance may facilitate valuation used in a buy/sell exchange or the buying and selling of animal semen for reproduction and bloodline extension.

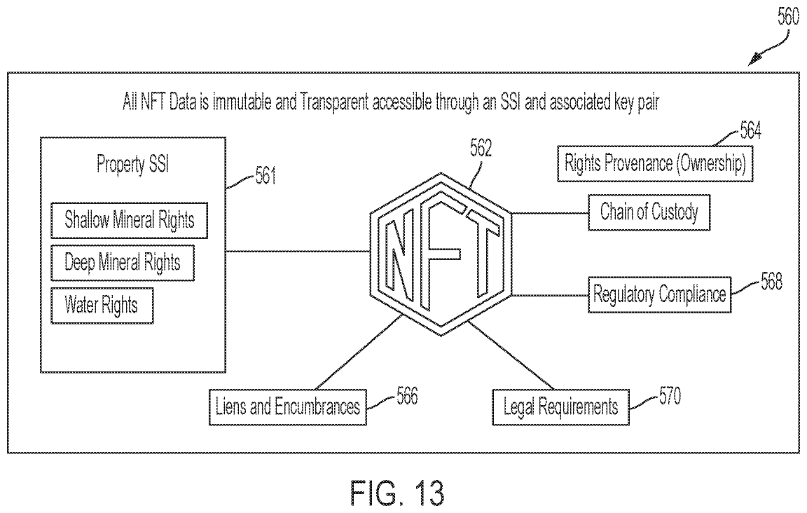

Turning now to FIG. 13, exemplary system 560 is configured to use system 10 and method 100 to create a decentralized verifiable custody and provenance of mineral and water rights 561 via NFTs 562, including without limitation, the provenance (ownership) 564, liens and encumbrances 566, regulatory compliance 568 and legal requirements 570. NFTs 562 allow for the strict control, compliance, and transfer procedures and processes needed to manage mineral/water rights between the owners who sell, lease, or consign their mineral rights and the parties that extract the resources from the earth and sell them. Additionally, blockchain smart contracts may be employed to define the terms and conditions of the extraction of minerals and/or water. Blockchain smart contracts may also be employed for remuneration of fees to the rights owners and to define the terms and conditions to lessee, consigner, or owner per the mineral/water rights contract. Additionally, Verifiable Self Sovereign Identification (VSSI) and a key pair may be leveraged to secure to the rights and provenance. By way of example, members may be assigned a VSSI and the NFTs record the transactions via VSSI and key pairing between the lessee, consigner and owner. The NFT also provides a digital record the execution flow and provides verifiable identity within the provenance and execution record of transactions. Additionally, NFTs may further allow for the quick sale, transfer or auction of the mineral/water rights.

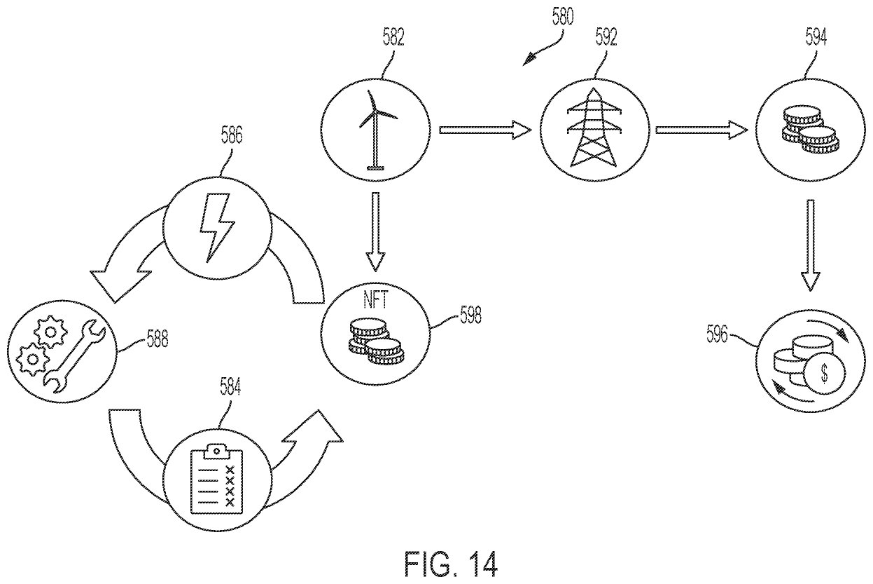

Turning now to FIG. 14, exemplary system 580 is configured to use system 10 and method 100 to create a decentralized verifiable custody and provenance electricity producing wind turbines/windmills 582. In an embodiment the invention, the wind turbine/windmill provenance 584 and performance 586 may be managed from initial requirements to full lifecycle, including any maintenance/repairs 588 via a blockchain-enabled digital twin (NFT) 590. NFT 590 allows for the strict control procedures and processes needed to manage wind turbines/windmills 582 between the vendors who sell, lease, or consign their wind turbines/windmills and the field or landowners. Additionally, blockchain smart contracts may be employed to define the terms and conditions of the wind turbine/windmill participation and for remuneration of fees to the wind turbine/windmill lessee, consigner, or owner per the well contracts. Verifiable Self Sovereign Identification (VSSI) and a key pair may also be leveraged to secure to the wind turbine/windmill 582 and provenance 584. By way of example, members are assigned a VSSI and the NFTs record the transactions via VSSI and key pairing between the lessee, consigner, and owner. NFT 590 thus provides a digital record of the execution flow and provides verifiable identity within the provenance and execution record of transactions. In a further aspect, the production output 592 of the wells may be tokenized in fungible tokens 594 based on a select production unit, such as kilowatts per hour. Tokens 594 may then be bought and sold on a tokenized commodities exchange 596 leveraging smart contracts for remuneration and transaction expediency.

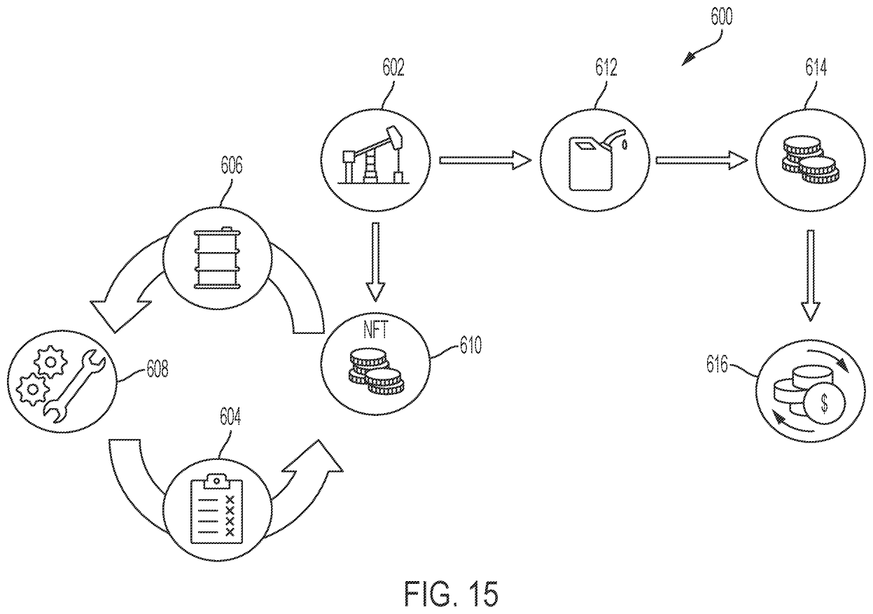

Turning now to FIG. 15, exemplary system 600 is configured to use system 10 and method 100 to create a decentralized verifiable custody and provenance oil, gas and water wells 602. Well provenance 604 and performance 606 may be managed, including any maintenance/repairs 608, from initial requirements to full well lifecycle management via a blockchain-enabled digital twin or NFT 610. NFT 610 allows for the strict control procedures and processes needed to manage wells between the vendors who sell, lease, or consign their wells and the field or landowners. Additionally, blockchain smart contracts may be employed to define the terms and conditions of the well participation and for remuneration of fees to the well lessee, consigner, or owner per the well contracts. Verifiable Self Sovereign Identification (VSSI) and a key pair may also be leveraged to secure to the well 602 and provenance 604. By way of example, members are assigned a VSSI and the NFTs record the transactions via VSSI and key pairing between the lessee, consigner and owner. NFT 610 provides a digital record the execution flow and provides verifiable identity within the provenance and execution record of transactions. In a further aspect, the production output 612 of the well 602 may be tokenized based on any suitable metric (i.e., oil in barrels; gas in cubic feet; or water in cubic yards). Fungible tokens 614 may then be bought and sold on a tokenized commodities exchange 616 leveraging smart contracts for remuneration and transaction expediency. NFTs and VSSI may also be used to delegate roles and authorities for NFT use and changes, and may further allow for the quick sale, transfer or auction of the well and/or its contents.

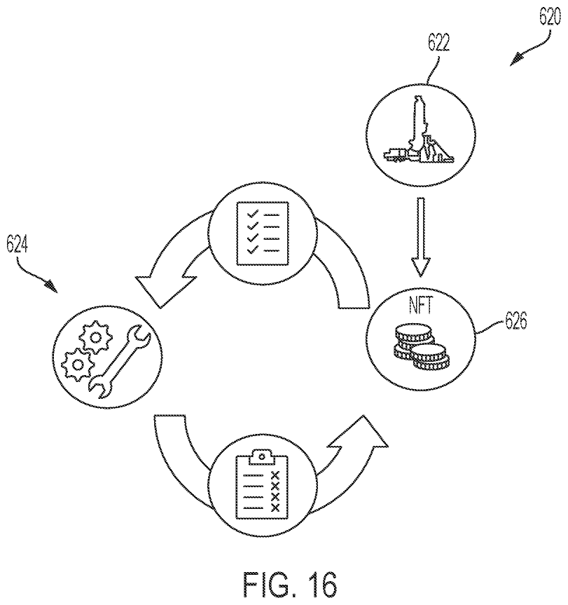

Turning now to FIG. 16, exemplary system 620 is configured to use system 10 and method 100 to create a decentralized verifiable custody chain for oil and gas rigs 622. Rig provenance management 624, from initial requirements to full rig lifecycle, may be recorded via a blockchain-enabled digital twin or NFT 626. NFT 626 allows for the strict control procedures and processes needed to manage rigs between the vendors who sell, lease or consign their rigs and the well/oil field companies/owners. Additionally, blockchain smart contracts may be employed to define the terms and conditions of the rig participation and for remuneration of fees to the rig lessee, consigner, or owner per the rig contracts. Verifiable Self Sovereign Identification (VSSI) and a key pair may be leveraged to secure to the rig 622 and provenance 624. By way of example, members are assigned a VSSI and the NFTs record the transactions via VSSI and key pairing between the lessee, consigner and owner. NFT 626 thus provides a digital record the execution flow and provided verifiable identity within the provenance and execution record of transactions. NFTs 626 and VSSI may also be used to delegate roles and authorities for NFT use and changes, as well as allow for the quick sale, transfer or auction of the rig.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “comprising,” “having,” “containing,” and the like shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

Furthermore, relative positional or directional terms used herein, such as for example, top, bottom, front, back, left side, right side, upward, downward, rightward, leftward, inward, outward, vertical, horizontal, clockwise, counterclockwise, etc., may have been used in the above-referenced description to describe a positional or directional relationship among elements as the elements are presented in the drawings. However, these terms should not limit in any way a specific orientation of the referenced feature, in practice.

Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A method for creating, maintaining and tracking a cryptographic digital asset tied to physical asset, the method comprising:
creating, via a first computing node within a distributed computing network, a digital asset file representative of a respective physical asset in possession of a first party;
initializing a digital asset generator to create a blockchain-enabled non-fungible token (NFT) of the digital asset file, wherein the NFT is assigned a unique digital asset identification (ID) code;
linking the unique digital asset ID code with a unique user ID code, wherein the unique user ID code is associated with the first party;
creating a first transaction block including the unique digital asset code and the unique user ID code, via the first computing node in a distributed blockchain ledger, to record possession of the cryptographic digital asset and the respective physical asset with the first party;
receiving an asset transfer request to transfer the cryptographic digital asset and respective physical asset to a second party;
verifying a second unique user ID code which is associated with the second party;
linking the cryptographic digital asset with the second unique user ID code; and
creating a second transaction block including the unique digital asset ID code and the second unique user ID code in the distributed blockchain ledger for recordation of the transfer of possession of the cryptographic digital asset and the respective physical asset from the first party to the second party.

2. The method of claim 1, wherein the physical asset comprises lease records and wherein the digital asset file is stored within a digital vault accessible to only the first and second parties.

3. The method of claim 1, wherein the physical asset comprises physical evidence and wherein the digital asset file is stored within a digital vault accessible to only the first and second parties.

4. The method of claim 1, wherein the physical asset comprises feature film and documentary materials.

5. The method of claim 1, wherein the physical asset comprises organs, body parts and pieces for transplant.

6. The method of claim 1, wherein the physical asset comprises intellectual property and trade secret materials.

7. The method of claim 1, wherein the physical asset comprises military contingency plans, operations plans or time phased force deployment data.

8. The method of claim 1, wherein the physical asset comprises livestock and animal provenance and bloodline authenticity materials.

9. The method of claim 1, wherein the physical asset comprises mineral and water rights materials.

10. The method of claim 1, wherein the physical asset comprises data and materials for an electricity generating windmill.

11. The method of claim 10, wherein electricity generated by the windmill is tokenized and sold on an associated tokenized commodities exchange.

12. The method of claim 1, wherein the physical asset comprises data and materials associated with an oil, water or gas well.

13. The method of claim 12, wherein output of the well is tokenized and sold on an associated tokenized commodities exchange

14. A decentralized computing system for creating, maintaining and tracking a cryptographic digital asset tied to physical asset, the decentralized computing system comprising:
a cryptographic digital asset marketplace configured to store a plurality of digital assets and a plurality of unique digital asset identification (ID) codes; and
a first computing node operatively connected to the cryptographic digital asset marketplace, the first computing node being programmed to:
create a digital asset file representative of a respective physical asset in possession of a first party;
initialize a digital asset generator to create a blockchain-enabled non fungible token (NFT) of the digital asset file, wherein the NFT is assigned a respective unique digital asset ID code;
link the respective unique digital asset ID code with a unique user ID code, wherein the unique user ID code is associated with the first party;
create a first transaction block including the respective unique digital asset ID code and the unique user ID code, via the first computing node in a distributed blockchain ledger, to record possession of the cryptographic digital asset and the respective physical asset with the first party;
receive an asset transfer request to transfer the cryptographic digital asset and respective physical asset to a second party;
verify a second unique user ID code which is associated with the second party;
link the cryptographic digital asset with the second unique user ID code;
create a second transaction block including the respective unique digital asset ID code and the second unique user ID code in the distributed blockchain ledger; and
store the digital asset file within a digital vault wherein the digital asset fill is accessible only to a respective party identified within the first transaction block or second transaction block.
